(19) United States
(12) Patent Application Publication
(10) Pub. No.: US 2007/0111042 A1
(43) Pub. Date: May 17, 2007

(54) Alkali-depleted glass & glass-based substrates for magnetic & magneto-optical recording media

(75) Inventor: Shashi B. Agarwal, Santa Clara, CA (US)

Correspondence Address: SEAGATE TECHNOLOGY LLC;c/o MCDERMOTT WILL & EMERY LLP, 600 13TH STREET, NW, WASHINGTON, DC, 20005-3096, US

(73) Assignee: SEAGATE TECHNOLOGY LLC

(21) Appl. No.: 11/274,318

(22) Filed: Nov. 16, 2005

(51) Int. Cl. G11B 5/706; C03C 21/00; C03C 23/00

(52) U.S. Cl. 428/846.9; 428/848.9; 65/31

(57) ABSTRACT

A method of manufacturing a glass or glass-based non-magnetic substrate for a magnetic or magneto-optical (MO) data/information storage and retrieval medium comprises sequential steps of providing a non-magnetic, glass or glass-based sheet having at least one surface and containing alkali metal ions and/or alkali metal-containing species; treating the sheet to reduce the concentration of the alkali metal ions and/or alkali metal-containing species in the sheet to a predetermined level for a predetermined depth below the at least one surface; and treating the at least one surface to substantially remove therefrom any alkali metal ions and/or alkali metal-containing species resulting from the previous step. Also disclosed are methods for manufacturing magnetic and MO media utilizing the thus-formed substrate and the media obtained thereby.

### FIELD OF THE DISCLOSURE

The present disclosure relates to improved methods for processing glass-containing substrates for use in manufacture of magnetic and magneto-optical (“MO”) recording media, and to improved magnetic and MO media comprising same. The disclosure has particular utility in the manufacture of glass substrate-based hard disk type magnetic or MO data/information storage and retrieval media.

### BACKGROUND OF THE DISCLOSURE

Magnetic and magneto-optical (MO) recording media are widely used in various applications, particularly in the computer industry. A portion of a conventional magnetic recording medium 1 utilized in disk form in computer-related applications is schematically depicted in FIG. 1 and comprises a non-magnetic substrate 10, typically of metal, e.g., an aluminum-magnesium (Al—Mg) alloy, having sequentially deposited on surface 10A a plating layer 11, such as of amorphous nickel-phosphorus (NiP), a polycrystalline underlayer 12, typically of chromium (Cr) or a Cr-based alloy, a magnetic layer 13, e.g., of a cobalt (Co)-based alloy, a protective overcoat layer 14, typically containing carbon (C), e.g., diamond-like carbon (“DLC”), and a lubricant topcoat layer 15, typically of a perfluoropolyether compound applied by dipping, spraying, etc. (A similar situation exists with MO media; however the component layer stack includes a plurality of magnetic, dielectric, and reflective layers).

In operation of medium 1, the magnetic layer 13 is locally magnetized by means of a write transducer or write head, to thereby record and store data/information. The write transducer creates a highly concentrated magnetic field which alternates direction based on the bits of information being stored. When the local magnetic field produced by the write transducer is greater than the coercivity of the recording medium layer 13, then the grains of the polycrystalline medium at that location are magnetized. The grains retain their magnetization after the magnetic field produced by the write transducer is removed. The direction of the magnetization matches the direction of the applied magnetic field. The pattern of magnetization of the recording medium can subsequently produce an electrical response in a read transducer, allowing the stored medium to be read. Thin film magnetic recording media such as illustrated in FIG. 1 are conventionally employed in disk form for use with disk drives for storing large amounts of data in magnetizable form, and typically, one or more disks are rotated on a central axis in combination with data transducer heads.

The continuing trend toward manufacture of very high areal density magnetic recording media at reduced cost provides an ongoing impetus for the development of lower cost materials, e.g., polymers, glasses, ceramics, and glass-ceramics composites as replacements for the conventional Al alloy-based substrates for magnetic disk media. However, poor mechanical and tribological performance, track misregistration (“TMR”), and poor flyability have been particularly problematic in the case of polymer-based substrates fabricated so as to essentially copy or mimic conventional hard disk design features and criteria. On the other hand, glass and glass-based materials, such as glass-ceramic composites, are attractive candidates for use as substrates for very high areal density disk recording media because of the requirements for high performance of the anisotropic thin film media and high modulus of the substrate.

As employed herein, the term “glass” is taken to include, in the broadest sense, non-crystalline silicates, aluminosilicates, borosilicates, boro-aluminosilicates, as well as polycrystalline silicates, aluminosilicates, and oxide materials; and the term “glass-ceramics” composite materials is taken to include materials consisting of crystalline particles bonded together either with a glass (i.e., vitreous) matrix or via fusion of the particles at their grain boundaries, as by sintering, as well as refractory nitrides, carbides, and borides when prepared in the form of bodies, as by sintering with or without a glass matrix or a silicon- or boron-containing matrix material, e.g., silicon nitride (Si₃N₄), silicon carbide (SiC), and boron carbide (B₄C). In addition, the term “glass-ceramics” is taken to include those materials which are melted and fabricated as true glasses, and then converted to a partly crystalline state, such materials being mechanically stronger, tougher, and harder than the parent glass, as well as non-porous and finer-grained than conventional polycrystalline materials.

As indicated supra, glass and glass-based materials such as glass-ceramic materials are attractive candidates for use as substrates for magnetic data/information storage and retrieval media, e.g., hard disks. However, a problem exists with such glass and glass-based materials in that they typically contain at least one alkali metal ion, e.g., sodium (Na), potassium (K), and lithium (Li) ions, and/or at least one alkali ion-containing species which, over time, migrates from the media substrate into one or more of the overlying thin films of the media layer stack, disadvantageously resulting in corrosion of one or more of the layers and attendant degradation of media properties and reliability.

In view of the foregoing, there exists a clear need for improved means and methodology for providing high modulus glass and/or glass-based substrates for magnetic and MO data/information storage and retrieval media, e.g., disk-shaped substrates, which means and methodology eliminate, or at least substantially mitigate, the deleterious effects on media performance and reliability resulting from out-migration of alkali metal ions and/or alkali metal-containing species from the glass or glass-based substrates.

The present disclosure addresses and solves problems and difficulties attendant upon the use of very hard, high modulus glass and/or glass-based materials, e.g., glass-ceramics, as substrate materials in the manufacture of very high areal density magnetic and MO recording media, while maintaining full capability with substantially all aspects of conventional automated manufacturing technology for the fabrication of thin-film magnetic media. Further, the methodology and means afforded by the present invention enjoy diverse utility in the manufacture of various other devices and media requiring low cost, high hardness non-magnetic substrates.

### SUMMARY OF THE DISCLOSURE

An advantage of the present disclosure is an improved method of manufacturing a glass or glass-based non-magnetic substrate for a magnetic or magneto-optical (MO) data/information storage and retrieval medium.

Another advantage of the present disclosure is an improved method of manufacturing a magnetic or magneto-optical (MO) data/information storage and retrieval medium comprising a glass or glass-based substrate.

Still another advantage of the present disclosure is an improved magnetic or magneto-optical (MO) data/information storage and retrieval medium comprising a glass or glass-based substrate.

Additional advantages and other aspects and features of the present disclosure will be set forth in the description which follows and in part will become apparent to those having ordinary skill in the art upon examination of the following or may be learned from the practice of the present disclosure. The advantages of the present disclosure may be realized and obtained as particularly pointed out in the appended claims.

According to an aspect of the present disclosure, the foregoing and other advantages are obtained in part by a method of manufacturing a glass or glass-based non-magnetic substrate for a magnetic or magneto-optical (MO) data/information storage and retrieval medium; comprising sequential steps of:

a) providing a non-magnetic, glass or glass-based sheet having at least one surface, the sheet containing alkali metal ions and/or alkali metal-containing species;

(b) treating the sheet to reduce the concentration of alkali metal ions and/or alkali metal-containing species within the sheet to a predetermined level for a predetermined depth below the at least one surface; and

(c) treating the at least one surface to substantially remove therefrom any alkali metal ions and/or alkali metal-containing species resulting from step (b).

Embodiments of the present disclosure include those wherein: step (a) comprises providing a glass or glass-based sheet comprising a material selected from the group consisting of: non-crystalline silicates, aluminosilicates, borosilicates, and boro-aluminosilicates; polycrystalline silicates, aluminosilicates, and oxides; and glass-ceramics composites; step (b) comprises heating the sheet at a temperature and for an interval sufficient to reduce the concentration of the alkali metal ions and/or alkali metal-containing species within the sheet to the predetermined level for the predetermined depth below the at least one surface; and step (c) comprises washing/rinsing the at least one surface with a liquid to substantially remove therefrom alkali metal ions and/or alkali metal-containing species resulting from step (b). Preferably, step (c) comprises washing/rinsing the at least one surface with an aqueous liquid.

Preferably, step (b) comprises diffusing the alkali metal ions and/or alkali metal-containing species from within the sheet to the at least one surface, and comprises heating the sheet at least about 150° C. for at least about 24 hrs.

Another aspect of the present disclosure is a method of manufacturing a magnetic or magneto-optical (MO) data/information storage and retrieval medium comprising a glass or glass-based substrate, comprising sequential steps of:

(a) providing a non-magnetic, glass or glass-based sheet having at least one surface, the sheet containing alkali metal ions and/or alkali metal-containing species;

(b) treating the sheet to reduce the concentration of alkali metal ions and/or alkali metal-containing species within the sheet to a predetermined level for a predetermined depth below the at least one surface;

(c) treating the at least one surface to substantially remove therefrom any alkali metal ions and/or alkali metal-containing species resulting from step (b); and

(d) forming a stack of thin film layers constituting the magnetic or MO medium on the at least one surface.

In accordance with embodiments of the present disclosure, step (a) comprises providing a glass or glass-based sheet comprising a material selected from the group consisting of: non-crystalline silicates, aluminosilicates, borosilicates, and boro-aluminosilicates; polycrystalline silicates, aluminosilicates, and oxides; and glass-ceramics composites; step (b) comprises heating the sheet at a temperature and for an interval sufficient to reduce the concentration of the alkali metal ions and/or alkali metal-containing species within the sheet to the predetermined level for the predetermined depth below the at least one surface; step (c) comprises washing/rinsing the at least one surface with a liquid to substantially remove therefrom alkali metal ions and/or alkali metal-containing species resulting from step (b); and step (d) comprises forming a layer stack for a magnetic or MO medium.

Preferred embodiments of the present disclosure include those wherein step (b) comprises diffusing the alkali metal ions and/or alkali metal-containing species within the sheet to the at least one surface, as by heating the sheet at least about 150° C. for at least about 24 hrs., and step (c) comprises washing/rinsing the at least one surface with an aqueous liquid.

Yet another aspect of the present disclosure is a magnetic or magneto-optical data/information storage and retrieval medium, comprising:

(a) a non-magnetic substrate in the form of a glass or glass-based sheet having at least one surface, the sheet containing alkali metal ions and/or alkali metal-containing species; and

(b) a stack of thin film layers constituting the magnetic or MO medium formed on the at least one surface; wherein:

the concentration of the alkali metal ions and/or alkali metal-containing species in the sheet is lower for a predetermined depth below the at least one surface than in a bulk region of the sheet.

According to embodiments of the present disclosure, the glass or glass-based sheet comprises a material selected from the group consisting of: non-crystalline silicates, aluminosilicates, borosilicates, and boro-aluminosilicates; polycrystalline silicates, aluminosilicates, and oxides; and glass-ceramics composites.

Additional advantages and aspects of the present invention will become readily apparent to those skilled in the art from the following detailed description, wherein embodiments of the present invention are shown and described, simply by way of illustration of the best mode contemplated for practicing the present invention. As will be described, the present invention is capable of other and different embodiments, and its several details are susceptible of modification in various obvious respects. Accordingly, the drawings and description are to be regarded as illustrative in nature, and not as limitative.

### BRIEF DESCRIPTION OF THE DRAWINGS

The following detailed description of the embodiments of the present invention can best be understood when read in conjunction with the following drawings, in which the same reference numerals are utilized for designating similar features, which features are not necessarily drawn to scale but rather are drawn as to best illustrate the pertinent features, wherein:

FIG. 1 illustrates, in schematic, simplified cross-sectional view, a portion of a conventional thin film magnetic data/information storage and retrieval medium; and

FIG. 2 illustrates, in schematic, simplified cross-sectional view, a portion of an embodiment of a thin film magnetic data/information storage and retrieval medium according to the present disclosure.

### DETAILED DESCRIPTION OF THE DISCLOSURE

The present disclosure addresses and solves problems and drawbacks associated with the use of low cost, high modulus materials, e.g., glass and glass-based materials, as non-magnetic substrates in the manufacture of high areal recording density magnetic and magneto-optical (MO) data/information storage and retrieval media, e.g., in hard disk form. More specifically, the present disclosure addresses and solves problems associated with increased corrosion resulting in degraded performance and loss of reliability of thin film magnetic and MO media with glass or glass-based substrates, vis-à-vis similar media with more conventional substrates, e.g., of Al-based alloy materials.

The present disclosure is based upon the discovery that the increased corrosion resulting in degraded media performance and loss of reliability associated with the use of glass and/or glass-based substrates is attributable to the presence in the substrates of alkali metal ions, e.g., sodium (Na), potassium (K), and lithium (Li) and/or various other species containing alkali metal ions, which alkali metal ions and/or alkali metal-containing species migrate over time from the substrates into the overlying stack of thin film layers which constitute the media.

Accordingly, the present disclosure is based upon the discovery/development of a simple, reliable, and cost-effective method for reducing the concentration of deleterious alkali metal ions and/or alkali metal-containing species in the glass or glass-based substrates to a predetermined level for a predetermined depth below the surface on which the thin film layer stack is formed. In this way, the amount of deleterious alkali metal ions and/or alkali metal-containing species migrating over time to the layer stack is significantly reduced and stable long term performance/reliability of the magnetic or MO media is therefore assured.

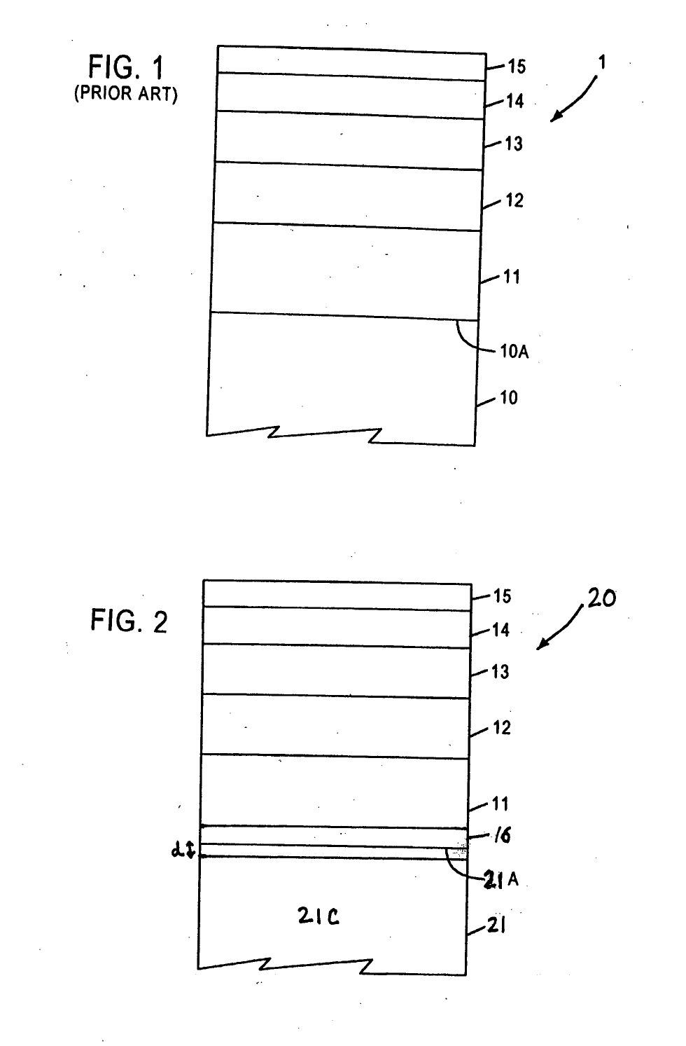

Referring to FIG. 2, shown therein, in schematic, simplified cross-sectional view, is a portion of an illustrative, but non-limitative embodiment of a thin film magnetic data/information storage and retrieval medium 20 according to the present disclosure. As illustrated, medium 20 is similar to medium 1 shown in FIG. 1 and includes a non-magnetic substrate 21, comprised of a glass or glass-based material selected from the group consisting of: non-crystalline silicates, aluminosilicates, borosilicates, and boro-aluminosilicates; polycrystalline silicates, aluminosilicates, and oxides; and glass-ceramics composites; having sequentially deposited or otherwise formed on substrate surface 21A an adhesion layer 16, e.g., of a metal such as Cr, Ti, or alloys thereof, a plating layer 11, such as of amorphous nickel-phosphorus (NiP), a polycrystalline underlayer 12, typically of chromium (Cr) or a Cr-based alloy, a magnetic layer 13, e.g., of a cobalt (Co)-based alloy, a protective overcoat layer 14, typically containing carbon (C), e.g., diamond-like carbon (“DLC”), and a lubricant topcoat layer 15, typically of a perfluoropolyether compound applied by dipping, spraying, etc.

Each of the above-enumerated glass or glass-based substrate materials typically includes a concentration (or amount) of at least one alkali metal element (i.e., Na, K, Li) in ionic form and/or in a more complex form of an alkali metal-containing species. According to the present disclosure, substrate 21 includes a region or strata 21B which extends for a depth d below surface 21A and contains a lower concentration of the at least one alkali metal element (in ionic or complex species form) than in the bulk region or portion 21C. As indicated above, by virtue of the presence of region or strata 21B with reduced concentration of alkali metal ions or alkali metal-containing species between the bulk region or portion 21C and the thin film layer stack, the amount of deleterious alkali metal ions and/or alkali metal-containing species available for migration over time to the overlying thin film layer stack is significantly reduced and stable long term performance/reliability of the magnetic medium 20 is therefore assured.

More concretely, according to the disclosure, region or strata 21B is formed to include deleterious alkali metal ions and/or alkali metal-containing species at a predetermined concentration level which is significantly reduced (e.g., by about 50%) as compared with bulk region 21C and extends for a predetermined distance d below substrate surface 21A.

A preferred method or procedure for forming region or strata 21B of a glass or glass-based substrate 21 with a predetermined depth and % reduction of concentration of deleterious alkali metal ions and/or alkali metal-containing species comprises providing a sheet of one of a suitable glass or glass-based substrate material having at least one surface, treating the sheet to reduce the concentration of alkali metal ions and/or alkali metal-containing species within the sheet to the predetermined level for the predetermined depth below the at least one surface, and treating the at least one surface to substantially remove therefrom any alkali metal ions and/or alkali metal-containing species resulting from the previous step.

Preferably, the glass or glass-based sheet of substrate material is selected from the group consisting of: non-crystalline silicates, aluminosilicates, borosilicates, and boro-aluminosilicates; polycrystalline silicates, aluminosilicates, and oxides; and glass-ceramics composites, and is of a thickness selected to provide a desired rigidity and strength, typically in the range from about 0.5 to about 1.25 mm thick. Formation of region or strata 21B preferably comprises heating the sheet at a predetermined temperature and interval sufficient to reduce the concentration of the alkali metal ions and/or alkali metal-containing species within the sheet to the predetermined level and depth d below surface 21A, and is followed by washing/rinsing surface 21A with a suitable liquid, preferably an aqueous liquid (e.g., deionized water which may contain appropriate amounts of at least one surfactant, wetting agent, etc.) to substantially remove therefrom alkali metal ions and/or alkali metal-containing species resulting from the previous step. In subsequent processing, the layer stack constituting the desired magnetic or MO medium is then formed over surface 21A in conventional manner.

Preferably, formation of region or strata 21B comprises thermally diffusing the alkali metal ions and/or alkali metal-containing species within substrate 21 to surface 21A. The depth d and concentration of alkali metal ions and alkali metal-containing species in region or strata 21B will depend upon the heating interval and temperature, and can be determined by one of ordinary skill for use in a particular application. By way of illustration only, and not limitation, a sheet of glass or glass-based substrate material of the aforementioned thickness suitable for use in the manufacture of hard disk media may be heated at least about 150° C. for at least about 24 hrs. to remove a sufficient amount of the alkali metal ions and/or alkali metal-containing species from the sheet for the desired depth d below the surface.

Thus, the present disclosure advantageously provides, as by processing techniques which can be readily practiced at low cost, improved methodologies and instrumentalities for providing high modulus glass and glass-based materials treated to form therein surfaces with reduced concentrations of deleterious alkali metal ions and/or alkali metal-containing species, thereby facilitating their use as substrates for stable and reliable high areal density thin film magnetic and/or MO recording media.

In the previous description, numerous specific details are set forth, such as specific materials, structures, reactants, processes, etc., in order to provide a better understanding of the present disclosure. However, the present disclosure can be practiced without resorting to the details specifically set forth. In other instances, well-known processing materials and techniques have not been described in detail in order not to unnecessarily obscure the present disclosure.

Only the preferred embodiments of the present disclosure and but a few examples of its versatility are shown and described in the present disclosure. It is to be understood that the present disclosure is capable of use in various other combinations and environments and is susceptible of changes and/or modifications within the scope of the concept of the disclosure as expressed herein.

What is claimed is:

1. A method of manufacturing a glass or glass-based non-magnetic substrate for a magnetic or magneto-optical (MO) data/information storage and retrieval medium; comprising sequential steps of:
(a) providing a non-magnetic, glass or glass-based sheet having at least one surface, said sheet containing alkali metal ions and/or alkali metal-containing species;
(b) treating said sheet to reduce the concentration of said alkali metal ions and/or alkali metal-containing species within said sheet to a predetermined level for a predetermined depth below said at least one surface; and
(c) treating said at least one surface to substantially remove therefrom any alkali metal ions and/or alkali metal-containing species resulting from step (b).

2. The method according to claim 1, wherein:
step (a) comprises providing a glass or glass-based sheet comprising a material selected from the group consisting of:
non-crystalline silicates, aluminosilicates, borosilicates, and boro-aluminosilicates;
polycrystalline silicates, aluminosilicates, and oxides; and
glass-ceramics composites.

3. The method according to claim 1, wherein:
step (b) comprises heating said sheet at a temperature and for an interval sufficient to reduce said concentration of said alkali metal ions and/or alkali metal-containing species within said sheet to said predetermined level for said predetermined depth below said at least one surface.

4. The method according to claim 3, wherein:
step (b) comprises diffusing said alkali metal ions and/or alkali metal-containing species from within said sheet to said at least one surface.

5. The method according to claim 3, wherein:
step (b) comprises heating said sheet at least about 150° C. for at least about 24 hrs.

6. The method according to claim 1, wherein:
step (c) comprises washing/rinsing said at least one surface with a liquid to substantially remove therefrom said alkali metal ions and/or alkali metal-containing species resulting from step (b).

7. The method according to claim 6, wherein:
step (c) comprises washing/rinsing said at least one surface with an aqueous liquid.

8. A method of manufacturing a magnetic or magneto-optical (MO) data/information storage and retrieval medium comprising a glass or glass-based substrate, comprising sequential steps of:
(a) providing a non-magnetic, glass or glass-based sheet having at least one surface, said sheet containing alkali metal ions and/or alkali metal-containing species;
(b) treating said sheet to reduce the concentration of said alkali metal ions and/or alkali metal-containing species within said sheet to a predetermined level for a predetermined depth below said at least one surface;
(c) treating said at least one surface to substantially remove therefrom any alkali metal ions and/or alkali metal-containing species resulting from step (b); and
(d) forming a stack of thin film layers constituting said magnetic or MO medium on said at least one surface.

9. The method according to claim 8, wherein:
step (a) comprises providing a glass or glass-based sheet comprising a material selected from the group consisting of:
non-crystalline silicates, aluminosilicates, borosilicates, and boro-aluminosilicates;
polycrystalline silicates, aluminosilicates, and oxides; and
glass-ceramics composites.

10. The method according to claim 8, wherein:
step (b) comprises heating said sheet at a temperature and for an interval sufficient to reduce the concentration of said alkali metal ions and/or alkali metal-containing species within said sheet to said predetermined level for said predetermined depth below said at least one surface.

11. The method according to claim 10, wherein:
step (b) comprises diffusing said alkali metal ions and/or alkali metal-containing species from within said sheet to said at least one surface.

12. The method according to claim 10, wherein:
step (b) comprises heating said sheet at least about 150° C. for at least about 24 hrs.

13. The method according to claim 8, wherein:
step (c) comprises washing/rinsing said at least one surface with a liquid to substantially remove therefrom said alkali metal ions and/or alkali metal-containing species resulting from step (b).

14. The method according to claim 13, wherein:
step (c) comprises treating said at least one surface with an aqueous liquid.

15. The method according to claim 8, wherein:
step (d) comprises forming a layer stack for a magnetic medium.

16. The method according to claim 8, wherein:
step (d) comprises forming a layer stack for a MO medium.

17. A magnetic or magneto-optical (MO) data/information storage and retrieval medium, comprising:
(a) a non-magnetic substrate in the form of a glass or glass-based sheet having at least one surface, said sheet containing alkali metal ions and/or alkali metal-containing species; and
(b) a stack of thin film layers constituting said magnetic or MO medium formed on said at least one surface; wherein:
the concentration of said alkali metal ions and/or alkali metal-containing species in said sheet is lower for a predetermined depth below said at least one surface than in a bulk region of said sheet.

18. The medium as in claim 17, wherein:
said glass or glass-based sheet comprises a material selected from the group consisting of:
non-crystalline silicates, aluminosilicates, borosilicates, and boro-aluminosilicates;
polycrystalline silicates, aluminosilicates, and oxides; and
glass-ceramics composites.
